(19) United States
(12) Patent Application Publication
(10) Pub. No.: US 2015/0277906 A1
(43) Pub. Date: Oct. 1, 2015

(54) INSTRUCTION SET FOR ARBITRARY CONTROL FLOW IN ARBITRARY WAVEFORM GENERATION

(71) Applicant: Raytheon BBN Technologies Corp.

(72) Inventors: Blake Robert Johnson, Somerville, MA (US); Brian C. Donovan, Arlington, MA (US); Colm A. Ryan, Cambridge, MA (US)

(73) Assignee: Raytheon BBN Technologies Corp.

(21) Appl. No.: 14/230,653

(22) Filed: Mar. 31, 2014

(51) Int. Cl. G06F 9/30; G06F 12/08

(52) U.S. Cl. CPC G06F 9/3005; G06F 12/0875; G06F 2212/452

(57) ABSTRACT

Embodiments for providing an arbitrary control flow architecture for an arbitrary waveform generator (AWG) are generally described herein. In some embodiments, an arbitrary control flow instruction set defines control operations for generating an arbitrary waveform. A processor is arranged to execute the arbitrary control flow instruction set from data stored in a system memory to generate an arbitrary waveform. A system memory may include a low-latency memory and a high-latency memory, wherein a cache controller may use prediction mechanisms to reduce the latency of fetching instruction and waveform data by copying that data to the low-latency memory before it is requested.

### GOVERNMENT RIGHTS

This case is a subject invention under government Contract No. C12J11269. The government has certain rights in this invention.

### BACKGROUND

Arbitrary waveform generators (AWGs) are devices that produce analog waveforms by converting a stored digital representation of a waveform into an analog output through a digital-to-analog converter (DAC). This gives AWGs considerably more flexibility than function generators, which may produce a small number of pre-computed waveforms such as sine, sawtooth, triangle, and square waves. Nonetheless, practical considerations of transfer time and memory size still limit the duration and complexity of the output waveforms of an AWG. Consequently, engineers have added limited sequencing capabilities to AWGs to allow playback of more complex waveforms by stitching together smaller components. This allows for re-use of component waveforms many times such that the final output is of longer duration than what could be directly stored in the AWG memory. It also reduces transfer of redundant information.

Sequencing typically involves construction of a sequence table, which defines the order in which waveforms are played along with arbitrary control flow instructions. In existing AWGs, these control-flow instructions are limited to repeated waveforms (basic looping) and non-conditional goto statements to jump to other sections of the waveform table. Rudimentary conditional elements may be implemented with event triggers to conditionally jump to an address in the waveform table upon receipt of an external trigger. This capability enables branching into the sequence table. Memory may be re-used using the concept of subsequences which allow for jumping to sections of the waveform table and then returning to the jump point in a manner similar to a subroutine or function call in a programming language.

Existing AWGs are limited in several ways. First, previous implementations have not allowed arbitrary combinations of control-flow constructs. For instance, any control-flow instruction may be conditional, so that, for example, subsequence execution could depend on external inputs. Alternatively, recursive control-flow structures may be constructed, i.e. nested subsequences may be possible. Second, event triggers are not sufficiently expressive to choose between branches of more than two paths. With wider, multi-bit input interfaces, higher-order branches may be constructed, e.g., with a 2-bit input you could have four choices.

Some applications require a low-latency conditional response to external information. One such application is quantum error correction, where the control systems apply a correction operation (a pulse) upon receipt of an error signal. It is expected that future quantum information processors will spend the majority of their execution time correcting errors. Consequently, the latency of the error correction step directly translates into the effective clock speed of such devices. The testing of high-speed communications protocols also involves sequences (i.e. symbols) that are chosen depending on interactions between the sender and receiver.

Low-latency applications place additional demands on branching AWGs because jumping between distant addresses in dynamic random access memory (DRAM) is subject to significant latency.

### BRIEF DESCRIPTION OF THE DRAWINGS

FIG. 1 illustrates an example of a waveform sequence according to an embodiment;

FIG. 2 depicts a block diagram representation of a an AWG according to an embodiment;

FIG. 3 illustrates an arbitrary control flow architecture for arbitrary waveform generators (AWGs) according to an embodiment; and

FIG. 4 illustrates an AWG system memory cache structure according to an embodiment.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass available equivalents of those claims.

Test equipment applications involve signal stimuli varying from advanced communication signals to the playback of captured real-world analog signals. Signal source instruments generate the signal stimulus that is applied to a device under test (DUT). Consequently, signal sources comprise a class of test instruments.

Embodiments described herein satisfy the demands of long sequences and low-latency by adding a cache hierarchy into the AWG memory structure. Moreover, embodiments described herein provide a complete instruction set for arbitrary control flow, wherein the arbitrary control flow instruction set provides for loops, conditional execution, and subroutine structures. Consequently, arbitrary control flow may be provided that allows flexible sequence design.

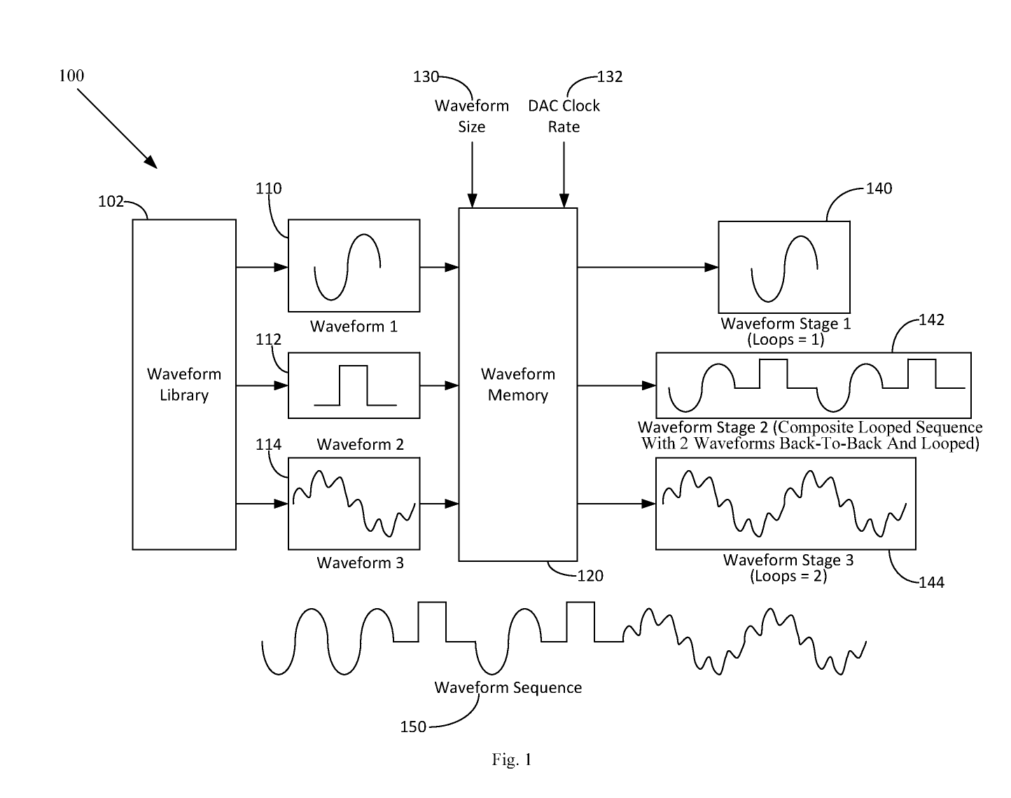

FIG. 1 illustrates an example of a waveform sequence 100 according to an embodiment. Arbitrary waveforms involve point-by-point user-defined waveform synthesis. This provides unlimited flexibility to the user to create custom waveforms not available on the instrument. The user loads waveform data codes 110, 112, 114 to instrument memory 120, and programs the waveform size 130 and DAC clock rate 132. The DAC clock rate 132 sets the time interval at which each data point is converted from digital data to an analog signal, and the waveform size 130 controls the total duration of the user-defined arbitrary waveform. Thus, sophisticated modulation is created and generated by the AWG and applied to a modulation input port on the high-frequency signal generator to create a modulated RF/microwave output. However, those skilled in the art will recognize that direct digital synthesis (DDS) may be used where a separate signal generator is not required.

Waveform sequences provide a mechanism to piece together specified or arbitrary waveforms in stages to create user-defined compound waveforms. Typically, a waveform library 102 provides the waveform data 110, 112, 114 used in the stages 140, 142, 144 of the waveform sequence. Waveform data 110, 112, 114 in the library 102 are reused and looped in a sequence to provide the flexibility to create long waveform sequences 150. The generation of the arbitrary waveforms will be described below.

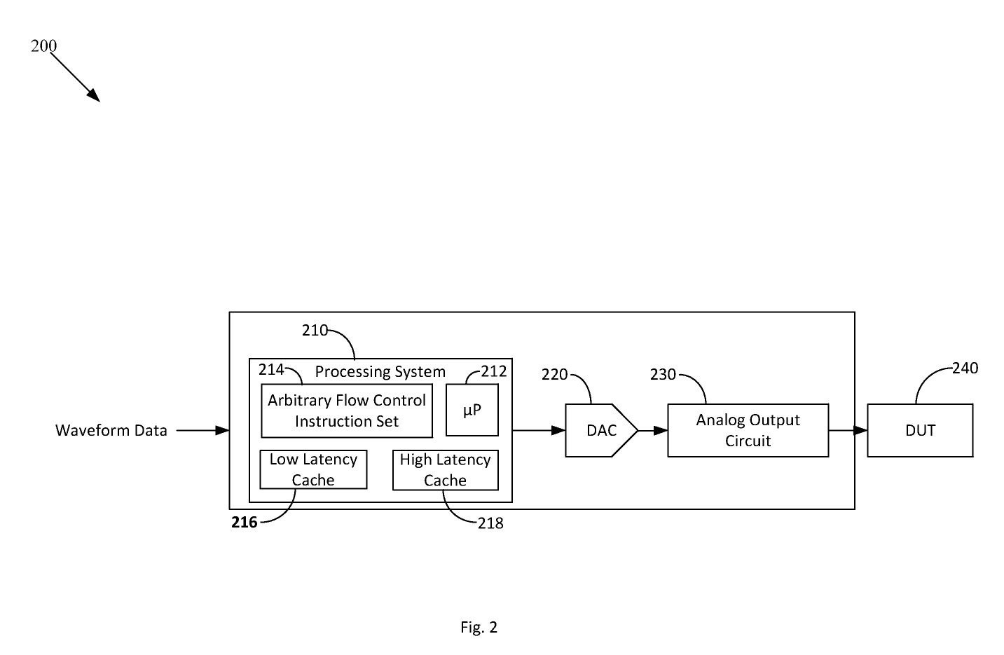

FIG. 2 depicts a block diagram representation of an AWG 200 according to an embodiment. In operation, a processing system 210 may receive waveform data describing an output analog signal. The waveform data may be received from a memory, a storage device, or the like. The processing system 210 may include a processor executing software, such as a general-purpose microprocessor, a dedicated application specific integrated circuit (ASIC), a field programmable gate array (FPGA), or the like. The processing system 210 includes a processor 212 that executes an arbitrary control flow instruction set 214 for defining the arbitrary waveform to be generated. A cache is provided for providing low-latency non-linear instruction flow, including a low-latency cache 216 and a higher-latency memory. To generate arbitrary waveforms according to the arbitrary control flow instruction set 214, the processor 212 fetches sequential instructions until it reaches a branch, at which point it may jump to a different location based upon comparing real-time input data with values in a comparison register (see below). The processor 212 also implements a cache controller so that whenever possible the next instruction may be fetched from the low-latency cache. This controller predicts the next instructions to execute, and loads those instructions from the high-latency memory into the low-latency cache. The cache controller further performs address translation so that instruction or waveform data requested by the processor 212 is fetched from the appropriate location in the cache.

The processed waveform data may be converted into an analog signal using a digital-to-analog converter (DAC) 220. The analog signal may be filtered by an analog output circuit 230, which may include an amplifier, an attenuator, a switch, a reconstruction filter, etc. The filtered analog signal may then be applied to a DUT 240.

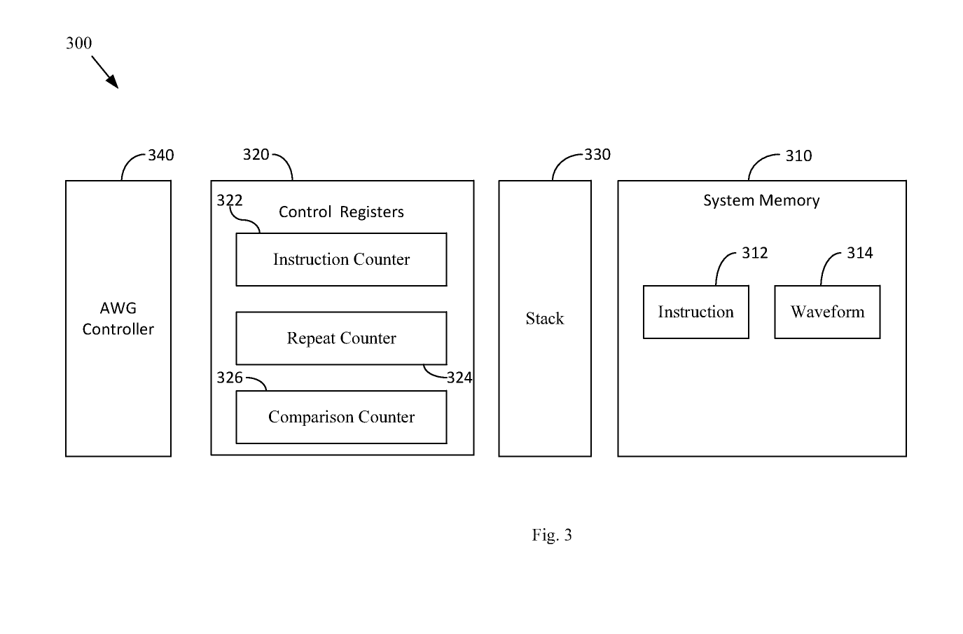

FIG. 3 illustrates an arbitrary control flow architecture 300 for arbitrary waveform generators (AWGs) according to an embodiment. Arbitrary control flow involves three concepts, i.e., sequences, loops (repetition) and conditional execution. According to an embodiment, the concept of subroutines is added to arbitrary control flow because of the value subroutines provide in structured programming and memory re-use.

An instruction set, and related system design involves segmenting AWG system memory 310 into two types, e.g., a waveform memory 312 and an instruction memory 314. In addition, an AWG according to an embodiment has four other resources available for managing the execution of the arbitrary control flow instruction set. Control registers 320 includes an instruction counter 322, a repeat counter 324 and a comparison register 326. A stack 330 is provided for returning to the current instruction and restoring state after calling a subroutine.

In FIG. 3, the instruction counter 322 points to the current address in instruction memory 312. An AWG controller 340 reads and executes operations in instruction memory 312 at the instruction pointer. Unless the instruction specifies otherwise, by default the controller 340 increments the instruction pointer upon executing each instruction in the instruction memory 312, thus fulfilling the sequential execution. Table 1 illustrates the available instructions for the AWG according to an embodiment.

TABLE 1

| | |
|---|---|
| CMP operator N | Compares the value of the comparison |
| | register to N with operators |
| WAVEFORM address | Indicates that the AWG should play back |
| length | length N data points starting at the given |
| | waveform memory address |
| TA-WAVEFORM | Indicates that the AWG may play back a |
| amplitude length | constant waveform of N points with the |
| | specified amplitude |
| LOAD count | Loads the given value into the repeat |
| | counter |
| REPEAT address | Decrements the repeat counter and jumps |
| | to the given address if the counter is |
| | greater than zero. |
| GOTO address | Jumps to the given address by updating |
| | the instruction counter |
| CALL address | Pushes the current instruction counter |
| | onto the stack, then jumps to the given |
| | address by updating the instruction |
| | counter |
| RETURN | Moves the top value on the stack to the |
| | instruction counter and jumps back to the |
| | instruction after the most recent CALL |
| | instruction |
| PREFETCH address | Loads the sequence or waveform data at |
| | the given address into the cache |

From Table 1, the available instructions includes CMP operator N, WAVEFORM address length, TA-WAVEFORM amplitude length, LOAD count, REPEAT address, GOTO address, CALL address, RETURN and PREFETCH address. GOTO, CALL and RETURN may have conditional versions which depend on the result of the most recent comparison (CMP) operator. CMP-Compares the value of the comparison register to N with any of these operators: =, ≠, >, <. So, (CMP≠0) would be true if the comparison register contains any value other than zero.

WAVEFORM address length indicates that the AWG should play back length N data points starting at the given waveform memory address. TA-WAVEFORM indicates that the AWG should play back length a constant waveform of N points with the specified amplitude.

The LOAD instruction loads the given value into the repeat counter. The REPEAT instruction decrements the repeat counters. If the resulting value is greater than zero, jumps are made to the given instruction address by updating the instruction counter. The GOTO instructions jumps to the given address by updating the instruction counter. The conditional version jumps if the prior CMP operator is true.

The CALL instruction pushes the current instruction counter onto the stack, and then jumps to the given address by updating the instruction counter. The conditional version jumps if the prior CMP operator is true. The RETURN instruction moves the top value on the stack to the instruction counter and jumps back to the instruction after the most recent CALL instruction. The conditional version jumps if the prior CMP operator is true. The PREFETCH instruction loads the sequence or waveform data at address into the cache.

These instructions easily facilitate two kinds of looping: iteration and while loops. The former is achieved through use of LOAD to set the value of the repeat counter, followed by the loop body, and terminated by REPEAT to jump back to the beginning of the loop. The latter is achieved by bookending the loop body with conditional GOTO statements that jump to the instruction following the loop.

Subroutines are implemented with the CALL and RETURN instructions. The address of a CALL instruction can indicate the first instruction in instruction memory of a subroutine. The subroutine may have multiple exit points, which may be marked by a RETURN instruction.

Conditional execution is directly supported by the conditional GOTO, CALL, and RETURN. Consequently, the stated instruction set may be used for arbitrary control flow.

PREFETCH helps to reduce latency from branching operations by loading data into a lower-latency domain at a predetermined time (rather than waiting for a cache miss). Instruction and waveform caching are described below.

According to an embodiment, an instruction set for AWGs provide more than a monolithic very wide instruction. Previous AWGs have only supported an instruction that tries to specify everything: waveform address and length, number of times to repeat the waveform, instruction address to jump to upon completion, and instruction address to jump to if a trigger event occurs. Limitations of existing hardware suggest that implementations of subroutines are really a software feature, and that subsequences are inlined, i.e., copied, in the AWG instruction memory.

Low-latency applications place additional demands on branching AWGs because jumping between distant addresses in dynamic random access memory (DRAM) is subject to significant latency. According to an embodiment, an AWG with multi-level memory caching, is provided to reduce memory latency by caching data in a higher speed memory before accessing a large DRAM. The System Memory is segmented into high and low latency domains.

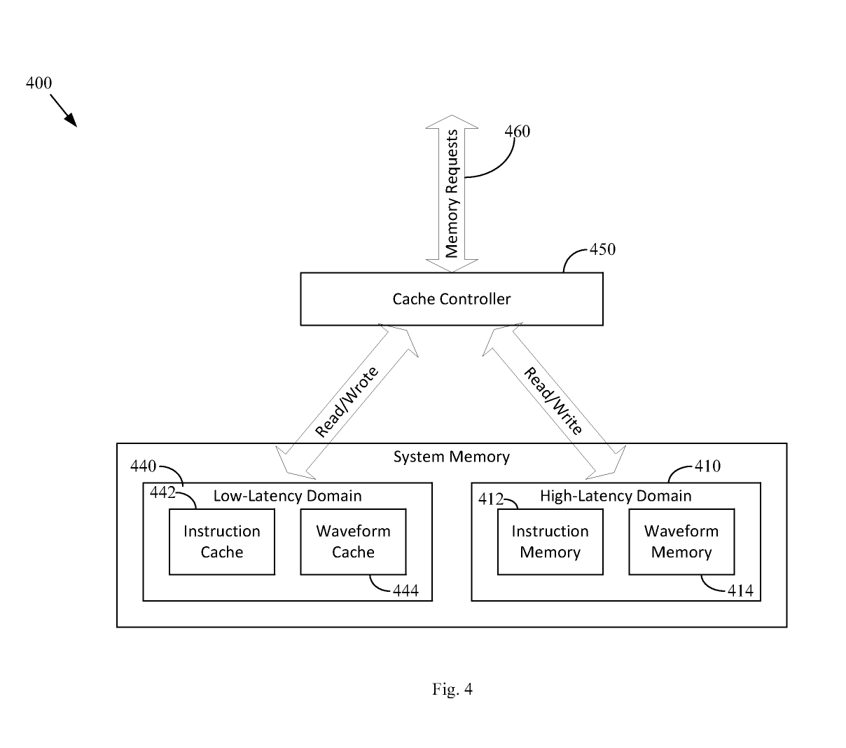

FIG. 4 illustrates an AWG system memory cache structure 400 according to an embodiment. The system memory 400 includes a high latency domain 410 and a low latency domain 440. The high latency domain 410 is a large memory area with high read/write latency, e.g., a large DRAM. The high latency domain 410 is segmented into instruction memory 412 and waveform memory 414 as described above with respect to FIG. 3. As shown in FIG. 4, the low latency domain 440 includes an instruction cache 442 and a waveform cache 444. Thus, the high latency domain 410 and the low latency domain 440 each include an instruction memory area 412, 442 and a waveform memory area 414, 444. The low-latency domain 440 is a smaller higher speed memory, e.g., block RAM in an FPGA, similarly segmented into two areas: instruction cache 442 and waveform cache 444.

As data, both instruction and waveform data are written into the system 400 by the cache controller 450 according to memory requests 460. The data type is indicated by the memory address. It is also possible to flag data to be pre-copied to the instruction memory 442 or waveform memory 444 of the low-latency domain 440 to ensure it is available immediately in the low latency domain 440, e.g., waveforms used for the inner loop of an arbitrary control flow structure.

After a write, a small number of instructions and waveform data points are read from the high latency domain 410 into their respective low-latency caches, e.g., instruction cache 442 and waveform cache 444. Memory reads 450 are serviced by the low-latency cache 440 when the requested address is stored in the cache, otherwise the cache is updated from the high latency domain 410.

According to an embodiment, the instruction cache 442 may include mechanisms that predict which instructions or waveforms may be accessed next in order to decrease the likelihood of a cache miss. An example mechanism may predict that 1) the subsequent instruction after the current one is the most likely to be requested next, and that 2) jumps in sequence memory are likely to be short, so that the distance between requested entries is likely to be small (this is often the case for loops). A cache structure that may facilitate both of these heuristics is a circular buffer centered on the current address of the instruction counter. In this structure, the addresses in the instruction cache may range from instructionCounter−cacheSize/2 to instructionCounter+cacheSize/2. When the instruction counter increments, the cache controller will read in one new instruction at instructionCounter+cacheSize/2 from the high latency domain 410. The high-latency read of the instruction will not impact program flow provided that the execution time of the current instruction, e.g., waveform playback, is longer than the read latency from the high latency domain 410. In the event of an instruction counter jump, forward or back, instructions are read from the high latency instruction memory 412 into the instruction cache 442 to re-center the buffer.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An arbitrary control flow architecture for an arbitrary waveform generator (AWG), comprising:
an arbitrary control flow instruction set for defining control operations for generating an arbitrary waveform;
a processor arranged to execute the arbitrary control flow instruction set to generate an arbitrary waveform; and
a system memory for storage of instruction and waveform data.

2. The arbitrary control flow architecture of claim 1, wherein the arbitrary control flow instruction set comprises elements for conditional execution, jumping, looping, and calling and returning from subroutines/subsequences.

3. The arbitrary control flow architecture of claim 1 further comprising a plurality of control registers, wherein the plurality of control registers include an instruction counter, a repeat counter and a comparison register.

4. The arbitrary control flow architecture of claim 3, wherein the instruction counter is incremented for sequencing execution of instructions and points to a current instruction address in system memory.

5. The arbitrary control flow architecture of claim 3, wherein the repeat counter is updated whenever the processor loops a set of instructions.

6. The arbitrary control flow architecture of claim 3, wherein the processor compares instruction data to the comparison register in order to conditionally execute an instruction.

7. The arbitrary control flow architecture of claim 3, wherein the comparison register may be updated in real-time by an external source.

8. The arbitrary control flow architecture of claim 3 further comprising a memory stack for maintaining data in a sequence for processing under the control of a plurality of registers by the processor.

9. The arbitrary control flow architecture of claim 8, wherein a current value of the instruction counter is copied to a top of the stack, or the top of the stack is copied to the instruction counter, to enable calling and returning from subroutines or creating nested or recursive control structures.

10. The arbitrary control flow architecture of claim 1, wherein the system memory includes a low-latency memory and a high-latency memory.

11. The arbitrary control flow architecture of claim 10, wherein the low-latency memory is segmented into a waveform cache and an instruction cache, and wherein the high-latency memory is segmented into a waveform memory and an instruction memory.

12. The arbitrary control flow architecture of claim 10, further comprising a cache controller that reads instructions and/or waveform data from a high-latency domain into respective low-latency caches.

13. The arbitrary control flow architecture of claim 12, wherein the cache controller minimizes latency of fetching instruction and/or waveform data by predicting what data will be requested next, and copying that data in advance from the high-latency domain into a low-latency domain.

14. The arbitrary control flow architecture of claim 11, wherein the instruction cache comprises a circular buffer centered on a current instruction counter.

15. The arbitrary control flow architecture of claim 12, wherein the cache controller performs address translation to accurately fetch the instruction or waveform data from the cache.

16. A method for providing an arbitrary control flow architecture for an arbitrary waveform generator (AWG), comprising:
providing an arbitrary control flow instruction set for defining control operations for generating an arbitrary waveform;
accessing, by a processor, data associated with instructions of the arbitrary control flow instruction set from a low latency cache prior to accessing the data from a high latency cache; and
executing, by a processor, accessed instructions of the arbitrary control flow instruction set to generate an arbitrary waveform.

17. The method of claim 16, wherein the executing, by a processor, accessed instructions of the arbitrary control flow instruction set further comprise executing the arbitrary control flow instruction set to perform conditional execution, jumping, looping, and calling and returning from subroutines/subsequences.

18. The method of claim 16 further comprising controlling, by the processor, a plurality of control registers, wherein the plurality of control registers include an instruction counter, a repeat counter and a comparison register.

19. The method of claim 18 further comprising incrementing the instruction counter for sequencing execution of instructions and pointing a pointer to a current instruction address in system memory.

20. The method of claim 18 further comprising updating the repeat counter whenever a set of instructions is looped.

21. The method of claim 18 further comprising comparing instruction data to the comparison register in order to conditionally execute an instruction.

22. The method of claim 18 further comprising updating the comparison register in real-time using an external source.

23. The method of claim 18 further comprising processing a memory stack, under the control of a plurality of registers by the processor, for maintaining data in a sequence.

24. The method of claim 23 further comprises copying a current value of the instruction counter to a top of the stack, or copying the top of the stack to the instruction counter, to enable calling and returning from subroutines or creating nested or recursive control structures.

25. The method of claim 16 further comprising segmenting the system memory into a low-latency memory and a high-latency memory.

26. The method of claim 25, wherein the segmenting the system memory into a low-latency memory and a high-latency memory further comprises segmenting the low-latency memory into a waveform cache and an instruction cache, and segmenting the high-latency memory into a waveform memory and an instruction memory.

27. The method of claim 25, further comprising reading, by a cache controller, instructions and/or waveform data from a high-latency domain into respective low-latency caches.

28. The method of claim 27 further comprising minimizing latency of fetching instruction and/or waveform data, by the cache controller, by predicting what data will be requested next, and copying that data in advance from the high-latency domain into a low-latency domain.

29. The method of claim 26 further comprises centering a circular buffer of the instruction cache on a current instruction counter.

30. The method of claim 27 further comprising performing, by the cache controller, address translation to accurately fetch the instruction or waveform data from the cache.
